(19) United States
(12) Patent Application Publication
(10) Pub. No.: US 2012/0127602 A1
(43) Pub. Date: May 24, 2012

(54) NOVEL THERMAL ACTUATOR DESIGN FOR THERMAL FLYING HEIGHT CONTROL SLIDER

(75) Inventors: Hui Li, Singapore (SG); Kensuke Amemiya, Singapore (SG)

(73) Assignee: Hitachi Asia Ltd., Hitachi Square (SG)

(21) Appl. No.: 12/950,544

(22) Filed: Nov. 19, 2010

(51) Int. Cl. G11B 21/02

(52) U.S. Cl. 360/75; G9B/21.003

(57) ABSTRACT

This invention relates to a slider that includes a thermal actuator for controlling the flying height of the slider over a disk in a HDD. The thermal actuator comprises a thermal insulator, a thermal heater and a thermal conductor. The thermal heater is proximate a bottom surface of a slider body on one side of a read/write element. The thermal conductor has a higher thermal coefficient of thermal expansion than a remainder of the slider body and is formed between the first thermal heater and the one side of the read/write element. The first thermal insulator is proximate the bottom surface of the slider body and adjacent to the first thermal heater on an opposing side of the first thermal heater.

### FIELD OF THE INVENTION

This invention relates to a Hard Disk Drive (HDD). More particularly, this invention relates to a slider that includes a read/write element that is positioned over a disk to read and write data. Still more particularly, this invention relates to a slider that includes a thermal insulator, a thermal heater and a thermal conductor for controlling the flying height of the read/write element over a disk in a HDD.

### SUMMARY OF THE PRIOR ART

Today's electronic devices require storage devices that are smaller in size with greater storage capacities. To increase storage capacity, the recording densities of hard disk drives have been increased. The slider-disk spacing has been reduced to less than 10 nm to increase recording density and reduce the size of the hard disk drives. However, those skilled in the art would like to further reduce flying height of a read/write element in the slider to prevent read and write faults from occurring.

To reduce the flying height of a read/write element, those skilled in the art have proposed to use a small resistance heater incorporated into the slider near the read/write element. By applying electrical current to the heater, the material around the resistance heater expands due to the thermal energy imparted to the material by the heater. The expansion of the material may be used to change the contour of a portion of the slider or to form a protrusion from the flying surface of the slider to reduce the flying height of the read/write element. Those skilled in the art are constantly trying to improve the power efficiency and maximize the reduction of the flying height provided by such small resistance heaters. However, the use of these resistance heaters in the slider is limited as the amount of thermal energy that can be introduced in the slider head is restricted a certain amount so as not to cause over heating or malfunction of the read/write element.

Thus, those skilled in the art are constantly striving to design for a configuration of a slider body that further improves the reduction in flying height of the read/write element that uses thermal heater.

### SUMMARY OF THE INVENTION

The above and other problems are solved and an advance in the art is made by a thermal actuator in accordance with this invention. A first advantage of this invention is that the use of the thermal actuator reduces the flying height of a read/write element over a rotating disk while read and/or write operations are being performed. A second advantage of this invention is that the thermal actuator can be easily fabricated since only a plate of thermal insulator and a plate of conductor are additionally added, compared to the traditional thermal actuator design. A third advantage of this invention is that an additional 1 nm flying height reduction can be obtained by applying the thermal actuator in accordance with this invention. A fourth advantage of this invention is that it can be used for future 10 Tb/inch² areal density magnetic recording.

In accordance with this invention, a slider for an HDD is configured in the following manner. The slider includes a slider body. The slider body has a top surface, a bottom surface, a leading surface, a trailing surface, a first side, and a second side. A read/write element is formed in a portion of the slider body proximate the trailing surface of the slider body. The read/write element may include a first shield at a first end of the read/write element, a pole at a second end of the read/write element, a read head between the first shield and a second shield, and write coils formed within the pole. Preferably the shields and pole are formed of a Ni—Fe compound while the read head is a magnetoresistive layer and write coils are formed of copper (Cu).

The slider body also includes a first thermal heater proximate the bottom surface of the slider body on a first side of the read/write element, a first thermal conductor having a higher thermal coefficient of thermal expansion than a remainder of the slider body proximate the bottom surface of the slider body and between the first thermal heater and the first side of the read/write element, and a first thermal insulator proximate the bottom surface of the slider body and adjacent the first thermal heater on an opposing side of the first thermal heater from the first thermal conductor.

In accordance with some embodiments of this invention, the first thermal heater imparts thermal energy to the first thermal conductor and cause the first thermal conductor to expand to form a protrusion including a portion of the read/write element and extending out of the bottom surface of the slider body to reduce a flying height of the read/write element over a disk rotating in said hard disk drive. In yet another embodiment of this invention, the first thermal conductors conducts the thermal energy to the first side of read/write element to expand to form a protrusion including a portion of the read/write element and extending out of the bottom surface of the slider body to reduce a flying height of the read/write element over a disk rotating in said hard disk drive.

In accordance with some embodiments of this invention, the slider body further comprises a second thermal heater proximate the bottom surface of the slider body on a second side of the read/write element distal from the first thermal heater, a second thermal conductor having a higher thermal coefficient of thermal expansion than the remainder of the slider body proximate the bottom surface of the slider body and between the second thermal heater and the second side of the read/write element. Preferably, the first thermal conductor and the second thermal conductor are elongated in shape.

In accordance with some embodiments of this invention, the second thermal heater imparts thermal energy to the second thermal conductor and the second thermal conductor conducts the thermal energy to the second side of the read/write element and expands with the second side of the read/write element to form the protrusion including the portion of the read/write element and extending out of the bottom surface of the slider body to reduce the flying height of the slider head over the disk rotating in the hard disk drive.

In accordance with some embodiments of this invention, the thermal coefficient of thermal expansion of the first thermal conductor and the second thermal conductor are substantially similar. In yet another embodiment of this invention, the first thermal heater and the first thermal conductor are not in contact. The second thermal heater and the second thermal conductor are not in contact.

In accordance with some embodiments of this invention, a circuitry is connected to the first thermal heater and the second thermal heater. The circuitry controls a supply of electricity to the first thermal heater and the second thermal heater. In some embodiments of this invention, the circuitry activates the first thermal heater and deactivates the second thermal heater in response to a read operation of the slider head. This causes a larger protrusion from the bottom surface around the read head as compared to the bottom surface around the write coils. In yet another embodiment of this invention, the circuitry activates the second thermal heater and deactivates the first thermal heater in response to a write operation of the slider head. This causes a larger protrusion from the bottom surface around the write coils as compared to the bottom surface around the read head. In still another embodiment of this invention, the electrical current supplied to the first thermal heater and the second thermal heater is different to cause the read/write element to protrude proportionately.

In accordance with this invention, a slider for an HDD may perform in the following manner. The slider applies an electrical current to a first thermal heater on a first side of a read/write element formed in a portion of a slider body proximate a trailing surface of the slider body. In response to the electrical current being applied, the first thermal heater generates thermal energy and imparts the thermal energy from the first thermal heater to a first thermal conductor that is situated between the first thermal heater and the read/write element proximate a bottom surface of the slider body. The slider then conducts the thermal energy through the first thermal conductor to the read/write element. The thermal energy causes the first thermal conductor and the read/write element to expand and forms a protrusion from the bottom surface of the slider body that includes a portion of the read/write element to reduce a flying height of the read/write element over a rotating disk. The first thermal heater is isolated from a remainder of the slider body with a first thermal insulator on an opposite side of the first thermal heater from the first thermal conductor.

In accordance with some embodiments of this invention, electrical current is applied to a second thermal heater on a second side of the read/write element formed in the portion of the slider body proximate the trailing surface of the slider body. In response to the electrical current being applied, thermal energy is generated in the second thermal heater. The thermal energy is imparted from the second thermal heater to a second thermal conductor that is situated between the second thermal heater and the read/write element proximate the bottom surface of the slider body. Thermal energy is then conducted through the second thermal conductor to the read/write element, causing the second thermal conductor and the read/write element to expand. Thus, a subsequent protrusion is formed from the bottom surface of the slider body that includes a portion of the read/write element to reduce the flying height of the read/write element over the rotating disk. The second thermal heater is isolated from a remainder of said slider body with a second thermal insulator on an opposite side of the second thermal heater from the second thermal conductor.

### BRIEF DESCRIPTION OF THE DRAWINGS

The above and other features and advantages of this invention are described in the Detailed Description set forth below and the following drawings:

FIG. 1 illustrating components of a HDD including a slider configured in accordance with invention; FIG. 2 illustrating a slider in accordance with an embodiment of this invention;

FIG. 3 illustrating a cross sectional view of the slider shown in FIG. 2 along plane A;

FIG. 4 illustrating the dimension of the thermal actuator;

FIG. 5 illustrating a slider head portion in which the thermal conductors have expanded in accordance with an embodiment of this invention;

FIG. 6 illustrating a slider head portion in which the thermal conductors and read/write element have expanded in accordance with an embodiment of this invention;

FIG. 7 illustrating a slider head portion in which the thermal conductors and read/write element have expanded uniformly in accordance with an embodiment of this invention;

FIG. 8 illustrating a block diagram showing connections between the electrical components of a system in accordance with an embodiment of this invention;

FIG. 9 illustrating a flow diagram of the process of lowering the flying height of the slider head in accordance with an embodiment of this invention;

FIG. 10 illustrating a graph comparing the protrusion against the distance to slider trailing edge; and

FIG. 11 illustrating a graph comparing the flying height against the distance to slider trailing edge.

### DETAILED DESCRIPTION

This invention relates to a Hard Disk Drive (HDD). More particularly, this invention relates to a slider that includes a read/write element that is positioned over a disk to read and write data. Still more particularly, this invention relates to a slider that includes a thermal insulator, a thermal heater and a thermal conductor for controlling the flying height of the read/write element over a disk in a HDD.

FIG. 1 illustrates HDD 100 that incorporates a slider head in accordance with an embodiment of this invention. HDD 100 is enclosed in housing 105. Inside housing 105, disk 130 made of a media that data may be written to and read from is mounted on a rotating platform (Not Shown). Slider 120 includes read and/or write heads for writing data to and reading data from disk 130. Articulated arm 115 is positioned over disk 130 and has slider 120 affixed to a free end of articulated arm 115 and is movable to place slider 120 in certain position over disk 130 to read data from or write data to a particular track of disk 130. Electronics 110 include all of the circuitry for controlling the process of reading data from and writing data to disk 130. In particular, electronics 110 include the circuitry for controlling the motor (Not Shown) for rotating disk 130; circuitry for positioning slider 120 in the proper position over disk 130 by articulating arm 115; circuitry for controlling slider 120; and circuitry to control the thermal heaters which will be discussed below. One skilled in the art will recognize that only those components of HDD 100 that are needed to understand the invention are described. A complete description of HDD 100 is omitted for brevity.

FIG. 2 is an enlarged perspective view of slider 120. Preferably, slider includes slider body 200 having a trailing surface 210 at one end of slider body 200 that faces away from the oncoming of rotation disk 130. Slider body 200 further includes leading surface 205 that faces the oncoming rotation of disk 130, top surface 220, and bottom or Air Bearing surface 215. Slider 120 is a structure formed by depositions of layers of material with base layers proximate leading surface 205 and the top layer are formed proximate trailing surface 210.

Slider body 200 also includes portion 225 proximate trailing surface 210 that includes read/write element 230 that is a structure formed within portion 225. One skilled in the art will note that only one read/write element 230 is included in portion 225 in this embodiment of the invention. However, more than one read/write element may be formed within section 225 without departing from this invention.

FIG. 3 illustrates a cross sectional view of slider body 200 of slider 120 along plane A shown in FIG. 2. Slider body 200 includes substrate 305 formed proximate leading surface 205. Preferably, substrate 305 is a layer of Al₂O₃—TiC. However, one skilled in the art will recognize that any common substrate may be used without departing from this invention. Portion 225 also known as the basecoat is then formed over layer substrate 305. Preferably, basecoat 225 is Al₂O_{3.} However, one skilled in the art will recognize that any common basecoat may be used without departing from this invention.

Slider body 200 includes read/write element 230 formed within basecoat 225. Read/write element 230 includes structures formed in basecoat 225. The structures include first shield 370, second shield 371, pole 372, read head 390 and write coils 380. Preferably, first shield 370, second shield 371, and pole 372 are structures formed in basecoat 225 proximate bottom surface 215. However, other configurations may be used without departing from this invention. Preferably first shield 370, second shield 371, and pole 372 are Ni—Fe material as is common in the art. Write coils 380 are also formed proximate bottom surface 215 in basecoat 225 and are preferably made of Copper (Cu). Read head 390 is also formed proximate bottom surface 215 in basecoat 225 and is preferably a magnetoresistive layer to provide magnetic bias. Read/write element may be configured in the following manner. First shield 370 is at a first end of the read/write element 230 while pole 372 is at a second end of the read/write element 230. Read head 390 is between first shield 370 and second shield 371 while write coils 380 are formed within pole 372. One skilled in the art will recognize that there are other possible configurations and exact configuration is left to one skilled in the art.

In this embodiment, a first thermal actuator comprising a thermal insulator, thermal heater and thermal conductor is formed in basecoat 225. First thermal heater 325 is formed proximate bottom surface 215 on a first side of the read/write element 230. A first thermal conductor 350 is formed proximate bottom surface 215 and between first thermal heater 325 and first side of read/write element 230. A first thermal insulator 330 is formed proximate bottom surface 215 and adjacent to first thermal heater 325 on an opposing side of first thermal heater 325 from first thermal conductor 350.

In this embodiment, first thermal conductor has a higher thermal coefficient of thermal expansion than the remainder of slider body 200. Preferably, first thermal conductor is Cu since Cu is used for write coils 380. This reduces manufacturing cost. One skilled in the art will recognize that any other thermal conductor materials may be used without departing from this invention. First thermal conductor is preferably elongated in shape along the same axis of shield 370. This is because an elongated thermal conductor will cause more linear expansion.

First thermal heater 325 and first thermal insulator 330 are adjacent to each other. First thermal insulator 330 prevents thermal energy produced by first thermal heater 325 from being imparted towards substrate 305. Hence, first thermal insulator 330 also directs thermal energy produced by first thermal heater 325 towards read/write element 230. Although first thermal insulator 330 is shown in contact with first thermal heater 325 in this embodiment, one skilled in the art will recognize that first thermal insulator 330 may not contact with first thermal heater 325 without departing from this invention. Preferably, first thermal insulator 330 has higher thermal resistance than the rest of slider body 200.

First thermal heater 325 is connected to electronics 110 (shown in FIG. 1) that contains circuitry to control first thermal heater 325. When electrical current is being applied to first thermal heater 325, first thermal heater 325 generates thermal energy responsive to the electrical current being applied, and imparts the thermal energy from first thermal heater 325 to first thermal conductor 350. First thermal conductor 350 expands due to the thermal energy and concurrently conducts the thermal energy towards read/write element 230. The thermal energy also cause read/write element 230 to expand as well. The expansion of first thermal conductor 350 and/or read/write element 230 forms a protrusion from bottom surface 215 that includes a portion of the read/element to reduce a flying height of read/write element 230 over a disk rotating in the hard disk drive. First thermal conductor 350 and first thermal heater 325 are preferably proximate bottom surface 215 of slider body 200. The proximity to the bottom surfaces causes and/or localizes the expansion of the first thermal conductor and/or read/write element 230 towards the bottom surface 215 of slider body 200.

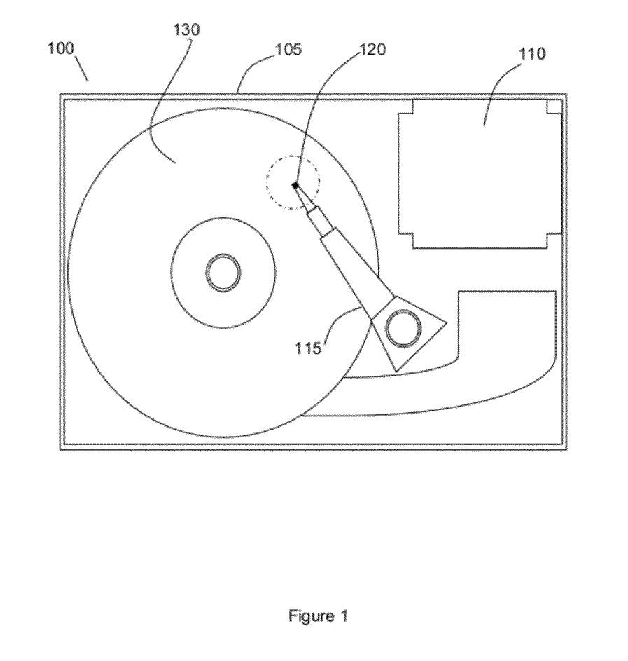

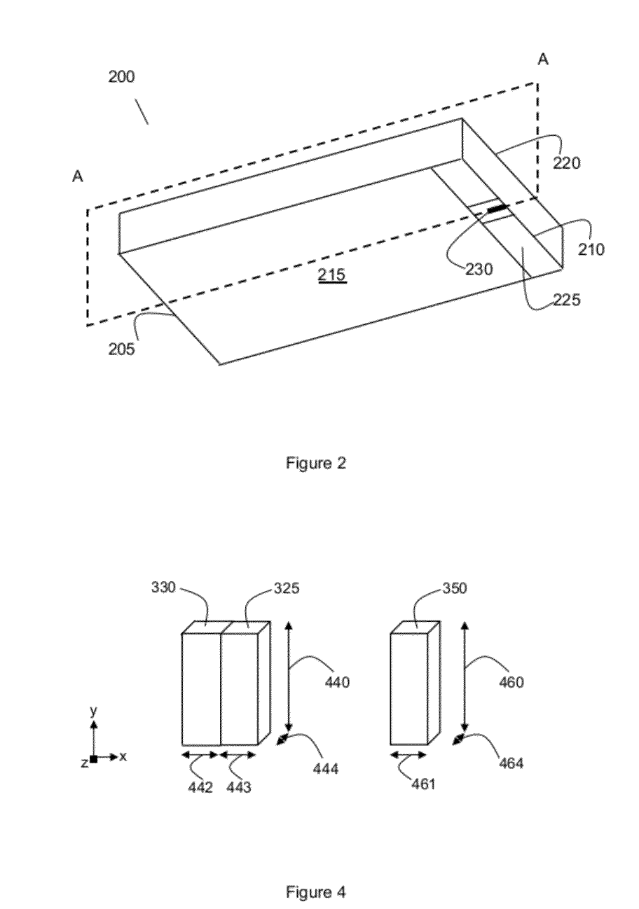

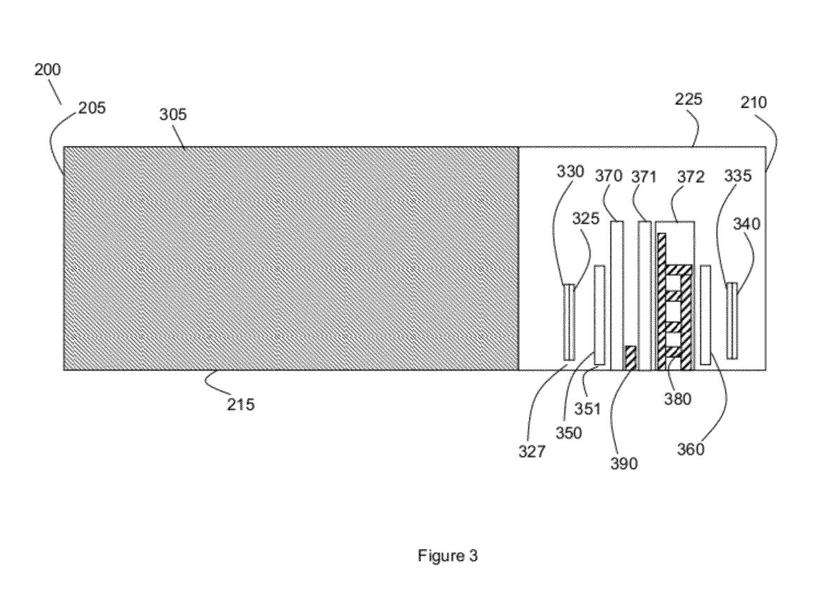

FIG. 4 illustrates first thermal heater 325, first thermal insulator 330 and first thermal conductor 350 to show the relationship of these components in accordance with the shown embodiment. The distance of first thermal insulator to bottom surface 215 is denoted as d1 as is shown by area 327 (Shown in FIG. 3). The distance of the first thermal conductor 350 to bottom surface 215 is denoted as d2 and is shown as area 351 (Shown in FIG. 3). The thickness of first thermal insulator 330, first thermal heater 325, and first thermal conductor 350 are denoted as t1 shown by arrow 442, t2 shown by arrow 443 and t3 shown by arrow 461 respectively. The width and length of first thermal insulator 330 and first thermal heater 325 are the same and are denoted as a1 shown by arrow 444 and b1 shown by arrow 440 respectively. As first thermal insulator 330 prevents thermal energy generated by first thermal heater from dissipating towards substrate 305, one skilled in the art will recognize that the length of first thermal insulator 330 only need to be equal or longer than the length of first thermal heater 325 and the exact configuration is left to one skilled in the art. The width and length of first thermal conductor 350 are denoted as a2 shown by 464 and b2 shown by arrow 460 respectively.

Preferably, d2 of area 351 is smaller than d1 327 in order to maximize the transfer of thermal energy from first thermal heater 325 to first thermal conductor 350 and/or read/write head element 230. Although the thermal actuator shown in this embodiment includes a thermal insulator, a thermal heater and a thermal conductor, other configurations such as, thermal heater with thermal insulator, or thermal heater with thermal conductor may also be provided in accordance with this invention.

In some embodiments, a second thermal conductor 360 is formed at the other side of read/write element 230. Second thermal conductor 360 causes more expansion proximate write coils 380. To improve the overall performance of the read/write element, a second thermal heater 335 and second thermal insulator 340 are also formed in the same manner as described with respect to the first thermal actuator. One skilled in the art will recognize that the materials used for first thermal insulator and second thermal insulator; first thermal heater and second thermal heater; first thermal conductor and second thermal conductor may be different without departing from this invention. Different material may be used because write coils 380 and read head 390 may be different in size and thus, the amount of expansion caused by thermal energy in these devices may vary. Hence, the choice of material is left to one skilled in the art. One skilled in the art may also use the same material and control the amount of thermal energy generated by first and second thermal heater by controlling the amount of electrical current applied to first and second thermal heater.

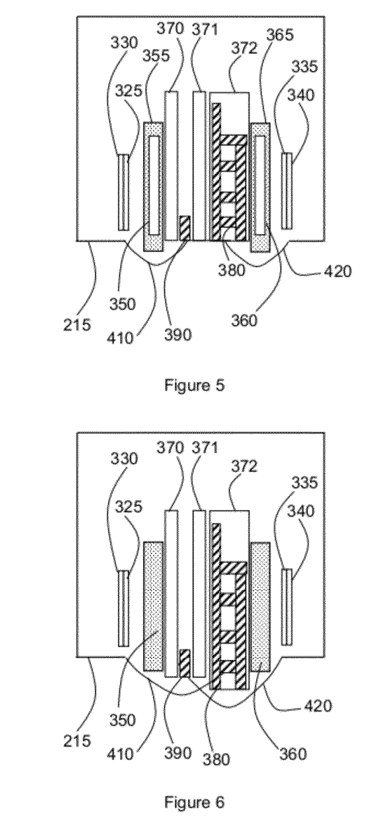

FIG. 5 illustrates a slider body in which the thermal conductors have expanded due to thermal energy imparted by the thermal heaters. When thermal energy is imparted from first thermal heater 325 to first thermal conductor 350, first thermal conductor 350 expands. First thermal conductor 350 expands linearly due to first thermal conductor being elongated in shape. Shaded portion 355 illustrates the expanded first thermal conductor which in turn causes bottom surface 215 to form a protrusion 410. Similar to first thermal conductor 350, second thermal conductor 360 expands when thermal energy is imparted from second thermal heater 335 or from first thermal conductor 350. Shaded portion 365 illustrates the expanded second thermal conductor which in turn causes bottom surface 215 to form a protrusion 420.

FIG. 6 illustrates a slider body when more electrical current is being applied to both first and second thermal heaters 325 and 335. When more electrical current is being applied to first and second thermal heaters 325 and 335, more thermal energy is generated from first and second thermal heaters 325 and 335. The increase in thermal energy imparted causes the expansion of first thermal conductor 350 (now shown in shaded representation) and second thermal conductor 360 (now shown in shaded representation) to increase protrusion of protrusions 410 and 420. In addition, thermal energy is also imparted to read head 390 and write coils 380. Read head 390 receives most of the thermal energy from first thermal conductor 350 and expands which in turn contributes further protrusion in protrusions 410 and 420. Similarly, write coils 380 receive most of the thermal energy from second thermal conductor 360 and expand which in turn contribute further protrusion in protrusions 410 and 420. Typically, write coils 380 expand more than read head 390 due to write coils 380 having a greater size than read head 390. Further, more thermal energy is generated by write coils 380 during a write operation. Hence, write coils 380 typically expand more than read head 390. The overall protrusion causes protrusion 410 and 420 to overlap.

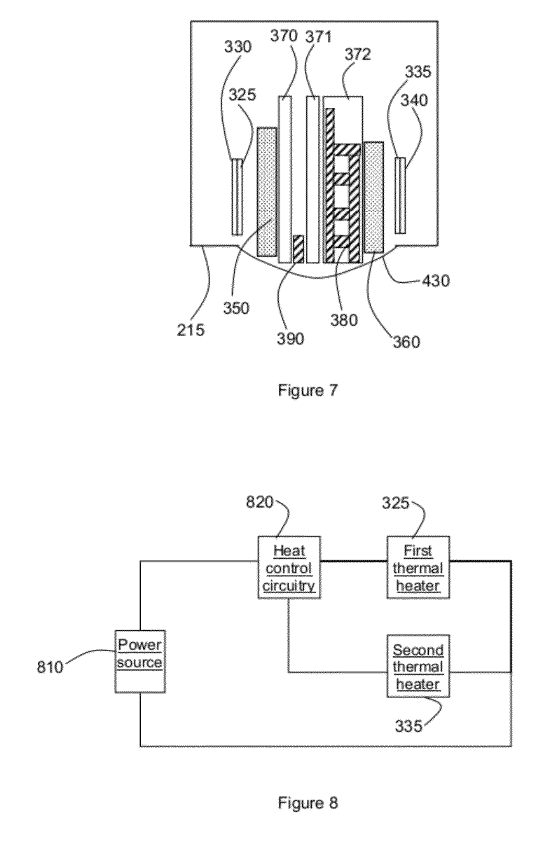

FIG. 7 illustrates a slider body with a uniform protrusion in which protrusions 410 and 420 merge to form one protrusion 430. One skilled in the art will recognize that protrusion 430 as shown in FIG. 7 is used for illustrative purposes and the exact protrusion may not ideally be as uniform as shown in FIG. 7. Protrusion 430 is formed by varying the amount of electrical current to first thermal heater 325 and second thermal heater 335. The varying of the amount of electrical current applied controls the amount of thermal energy to be generated by first thermal heater 325 and second thermal heater 335 which in turn controls the amount of expansion in first thermal conductor 350 and second thermal conductor 360, and the amount of thermal energy imparted on to read head 390 and write coils 380. One skilled in the art will recognize that protrusion 430 may also be formed by varying the different material used in first and second thermal conductor with different thermal coefficient of thermal expansion to reach the same result. The exact configuration is left to one skilled in the art.

Furthermore, the amount of electrical current to first thermal heater 325 and second thermal heater 335 may be varied to achieve the protrusions 410 and 420 as shown in FIG. 6. The varying of the amount of electrical current applied controls the amount of thermal energy to be generated by first thermal heater 325 and second thermal heater 335 which in turn controls the amount of expansion in first thermal conductor 350 and second thermal conductor 360, and the amount of thermal energy imparted on to read head 390 and write coils 380. This allows one to control the desired protrusion of the read/write element 230 based on whether the read/write element 230 is operating in either read or write mode.

FIG. 8 illustrates of electrical devices in accordance with this invention. Power source 810 is connected to both first thermal heater 325 and second thermal heater 335. Heat control circuitry 820 is between the connection power source 810 and both first and second thermal heaters 325 and 335. Heat control circuitry 820 controls the amount of electrical current to first and second thermal heaters 325 and 335. Heat control circuitry 820 may also be connected to circuitry in electronics 110 for controlling the operation of the slider body in order to control the electrical current to first and second thermal heaters 325 and 335 according to the operation of the read/write element 230. For example, during read operation, heat control circuit may direct all electrical current to first thermal heater 325 to cause the protrusion to form such that the protrusion includes the portion closer to read head 390. The formation of the protrusion including the portion closer to read head 390 reduces the flying height between the read head and the disc rotating under the slider body to improve the read operation. During a write operation, heat control circuitry 820 may direct all of the electrical current to second thermal heater 335 to cause a protrusion to form that includes the portion closer to write coils 380 to reduce the flying height between the write coil and the disc rotating under the slider body to improve the write operation.

In some embodiments of this invention, heat control circuitry 820 may apportion the electrical current to both first and second thermal heaters 325 and 335. Heat control circuitry 820 may apportion the electrical current according to the operation of the read/write element 230. For example, during read operation, heat control circuit may apportion more electrical current to first thermal heater 325. While in write operation, heat control circuit may apportion more electrical current to second thermal heater 335. Thus, the flying height is reduced in accordance to read or write operation.

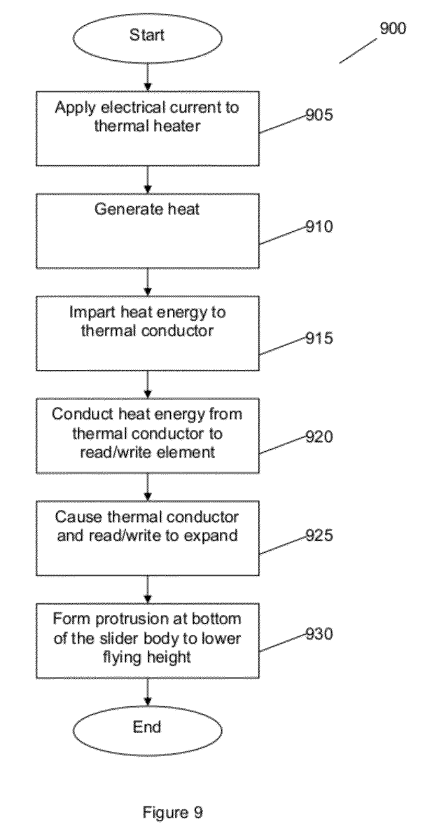

FIG. 9 illustrates a flow diagram of process 900 of lowering the flying height of the slider head. Electrical current is first applied to thermal heater in step 905. Thermal heater generates thermal energy in response to electrical current being applied in step 910. The thermal energy from thermal heater is imparted to thermal conductor in step 915. The thermal energy is subsequently conducted from thermal conductor to the read/write element in step 920. The thermal energy causes thermal conductor and read/write element to expand in step 925. Thus, the expansion of the thermal conductor and the read/write element causes a protrusion from bottom surface 215 of the slider body 200 to form that includes a portion of read/write element 230 to reduce a flying height of the read/write element 230 over a rotating disk. Process 900 then ends.

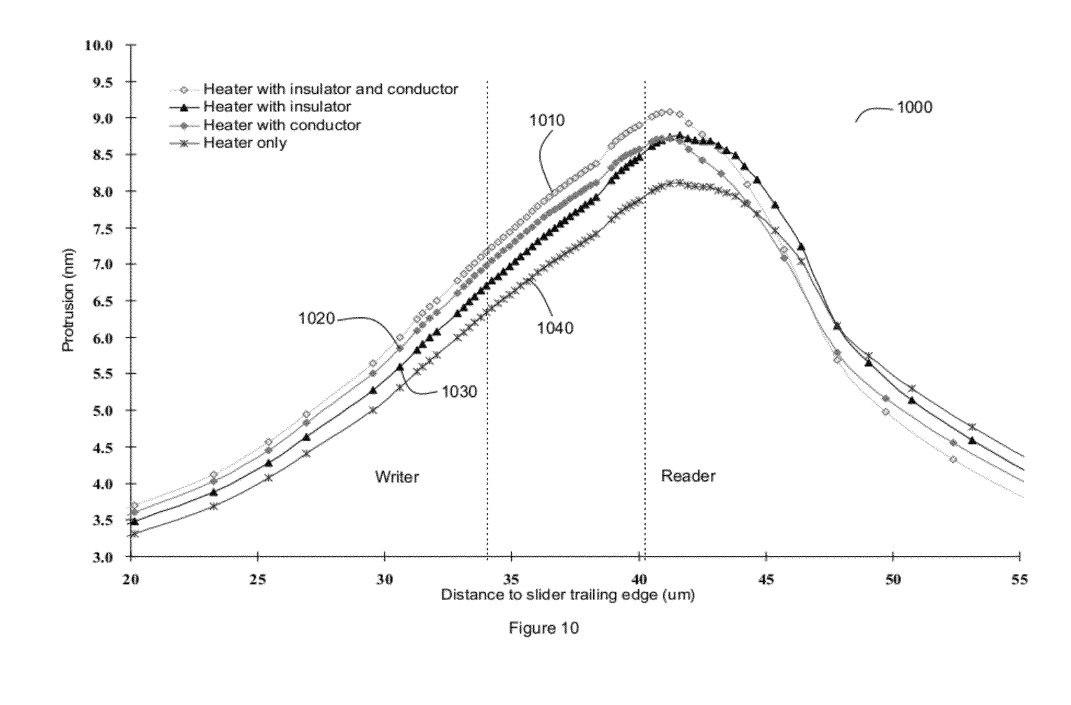

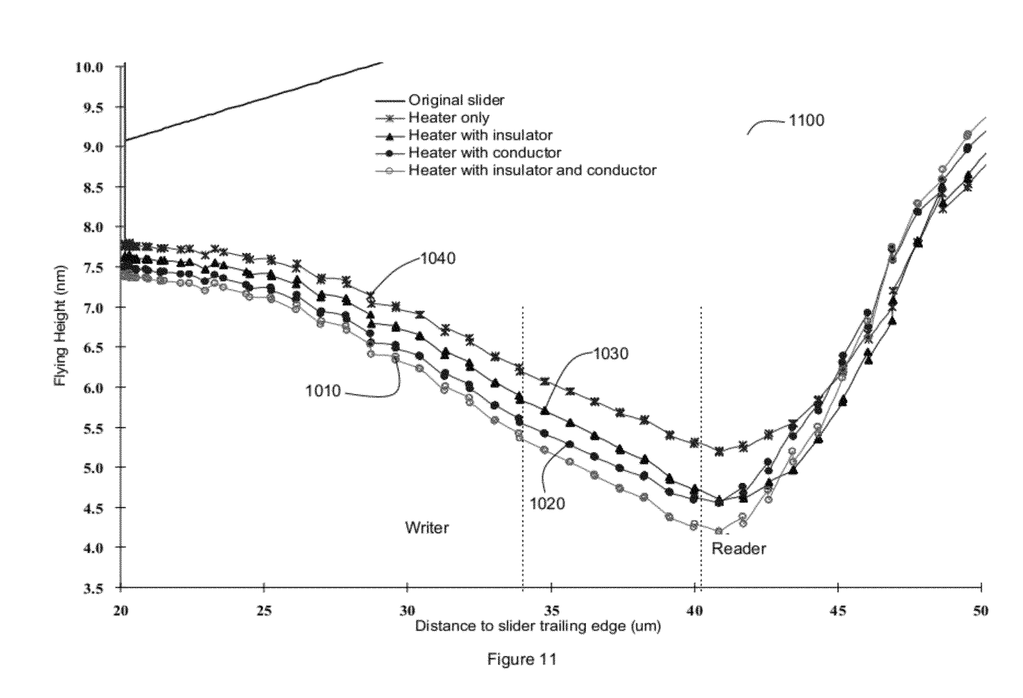

FIG. 10 illustrates a graph 1000 comparing the protrusion against the distance to slider trailing edge based on different types of thermal actuator configurations. The configuration of thermal insulator, thermal heater and thermal conductor is denoted as configuration 1010. The configuration of thermal insulator and thermal heater is denoted as configuration 1030. The configuration of thermal heater and thermal conductor is denoted as configuration 1020. The configuration of thermal heater is denoted as configuration 1040. Based on graph 1000, configurations 1010, 1020 and 1030 can achieve a larger protrusion than configuration 1040. Correspondingly, the flying height profiles are also compared in FIG. 11. Configurations 1020 and 1030 achieve lower flying height compared to configuration 1040 which is a commonly used thermal flying height control actuator. The lowest flying height is obtained in configuration 1010.

A summary of flying height of the slider with different configuration is provided in table 1 below.

| | Flying Height (nm) | | |
|---|---|---|---|
| | Lowest | At read | At write |
| Configuration | point | head | coils |
| Without heat actuator | 9.00694 | 11.2337 | 10.5735 |
| Thermal heater only (1040) | 5.19120 | 5.31658 | 6.19342 |
| Thermal insulator and heater (1030) | 4.57229 | 4.74282 | 5.84614 |
| Thermal heater and conductor (1020) | 4.55168 | 4.62212 | 5.55493 |
| Thermal insulator, heater and | 4.18645 | 4.28841 | 5.36152 |
| conductor (1010) | | | |

Based on table 1, it can be found that configuration 1030 achieves a flying height reduction of 0.6 nm at the read head and 0.4 nm at the write coils. Configuration 1020 achieves a flying height reduction of 0.7 nm at the read head and 0.6 nm at the write coils. Further, configuration 1010 achieves a flying height reduction of 1.1 nm at the read head and 0.8 nm at the write coils. The results show a significant reduction of the flying height of the slider by applying thermal insulator and thermal conductor or the combination in addition to thermal heater.

The above is a description of embodiments of this invention. It is expected that those skilled in the art can and will design alternative embodiments that infringe this invention as set forth in the following claims.

What is claimed is:

1. A slider for a hard disk drive comprising:
a slider body having a top surface, a bottom surface, a leading surface, a trailing surface, a first side, and a second side;
a read/write element formed in a portion of said slider body proximate said trailing surface of said slider body;
a first thermal heater proximate said bottom surface of said slider body on a first side of said read/write element;
a first thermal conductor having a higher thermal coefficient of thermal expansion than a remainder of said slider body proximate said bottom surface of said slider body and between said first thermal heater and said first side of said read/write element; and
a first thermal insulator proximate said bottom surface of said slider body and adjacent said first thermal heater on an opposing side of said first thermal heater from said first thermal conductor.

2. The slider according to claim 1 wherein said first thermal heater imparts thermal energy to said first thermal conductor and cause said first thermal conductor to expand to form a protrusion including a portion of said read/write element and extending out of said bottom surface of said slider body to reduce a flying height of said read/write element over a disk rotating in said hard disk drive.

3. The slider according to claim 2 wherein said first thermal conductors conducts said thermal energy to said first side of read/write element to expand to form a protrusion including a portion of said read/write element and extending out of said bottom surface of said slider body to reduce a flying height of said read/write element over a disk rotating in said hard disk drive.

4. The slider according to claim 3 further comprising:
a second thermal heater proximate said bottom surface of said slider body on a second side of said read/write element distal from said first thermal heater;
a second thermal conductor having a higher thermal coefficient of thermal expansion than said remainder of said slider body proximate said bottom surface of said slider body and between said second thermal heater and said second side of said read/write element.

5. The slider according to claim 4 wherein said second thermal heater imparts thermal energy to said second thermal conductor and said second thermal conductor conducts said thermal energy to said second side of said read/write element and expands with said second side of said read/write element to form said protrusion including said portion of said read/write element and extending out of said bottom surface of said slider body to reduce said flying height of said slider head over said disk rotating in said hard disk drive.

6. The slider of claim 4 wherein thermal coefficient of thermal expansion of said first thermal conductor and said second thermal conductor are substantially similar.

7. The slider of claim 4 wherein said first thermal heater and said first thermal conductor are not in contact.

8. The slider of claim 4 wherein said second thermal heater and said second thermal conductor are not in contact.

9. The slider of claim 4 wherein said first thermal conductor and said second thermal conductor are elongated in shape.

10. The slider of claim 4 wherein said read/write element comprises:
a first shield at a first end of said read/write element;
a pole at a second end of said read/write element;
a second shield between said first shield and said pole;
a read head between said first shield and said second shield; and
write coils formed within said pole.

11. The slider of claim 10 wherein said shield comprises Ni—Fe.

12. The slider of claim 10 wherein said pole comprises Ni—Fe.

13. The slider of claim 10 wherein said write coils comprise Copper.

14. The slider of claim 10 wherein said read head comprises a magnetoresistve layer.

15. The slider of claim 4 further comprising:
a circuitry connected to said first thermal heater and said second thermal heater.

16. The slider of claim 15 wherein said circuitry controls a supply of electricity to said first thermal heater and said second thermal heater.

17. The slider of claim 15 wherein said circuitry activate said first thermal heater and deactivate said second thermal heater in response to a read operation of slider head.

18. The slider of claim 17 wherein said circuitry activate said second thermal heater and deactivate said first thermal heater in response to a write operation of said slider head.

19. The slider of claim 15 wherein said electricity supplied to said first thermal heater and said second thermal heater is different to cause said read/write element to protrude proportionately.

20. A method of operating a slider head over a disk drive comprising:
applying an electrical current to a first thermal heater on a first side of a read/write element formed in a portion of a slider body proximate a trailing surface of said slider body;
generating thermal energy in said first thermal heater responsive to said electrical current being applied;
imparting said thermal energy from said first thermal heater to a first thermal conductor that is situated between said first thermal heater and said read/write element proximate a bottom surface of said slider body;
conducting said thermal energy through said first thermal conductor to said read/write element;
causing said first thermal conductor and said read/write element to expand; and;
forming a protrusion from said bottom surface of said slider body that includes a portion of said read/write element to reduce a flying height of said read/write element over a rotating disk.

21. The method of claim 20 further comprising:
isolating said first thermal heater from a remainder of said slider body with a first thermal insulator on an opposite side of said first thermal heater from said first thermal conductor.

22. The method of claim 21 further comprising:
applying said electrical current to a second thermal heater on a second side of said read/write element formed in said portion of said slider body proximate said trailing surface of said slider body;
generating thermal energy in said second thermal heater responsive to said electrical current being applied;
imparting said thermal energy from said second thermal heater to a second thermal conductor that is situated between said second thermal heater and said read/write element proximate said bottom surface of said slider body;
conducting said thermal energy through said second thermal conductor to said read/write element;
causing said second thermal conductor and said read/write element to expand; and
forming a subsequent protrusion from said bottom surface of said slider body that includes a portion of said read/write element to reduce said flying height of said read/write element over said rotating disk.

23. The method of claim 22 further comprising:
isolating said second thermal heater from a remainder of said slider body with a second thermal insulator on an opposite side of said second thermal heater from said second thermal conductor.

24. The method of claim 22 wherein said protrusion and said subsequent protrusion overlap.

25. The method of claim 22 further comprising:
controlling said amount of electrical current applied to said first and second thermal heaters to control the amount of expansion of said first and second thermal conductors.
